(19) United States
(12) Patent Application Publication
(10) Pub. No.: US 2005/0242344 A1
(43) Pub. Date: Nov. 3, 2005

(54) Method of forming electron emission source, the electron emission source, and electron emission device including the electron emission source

(76) Inventors: Hyun-Jee Lee, Suwon-si (KR); Chang-Wook Kim, Suwon-si (KR)

Correspondence Address: Robert E. Bushnell, Suite 300, 1522 K Street, N.W., Washington, DC, 20005-1202, US

(21) Appl. No.: 11/117,570

(22) Filed: Apr. 29, 2005

(30) Foreign Application Priority Data
Apr. 29, 2004 (KR) 10-2004-0030257

(51) Int. Cl. H01J 1/00

(52) U.S. Cl. 257/40

(57) ABSTRACT

A method of forming an electron emission source, which includes: providing a carbon nanotube layer on a substrate; affixing the carbon nanotube layer to an organosiloxane-based material; curing the organosiloxane-based material affixed to the carbon nanotube layer; separating a carbon nanotube-polyorganosiloxane polymer composite film from the substrate; laminating the carbon nanotube-polyorganosiloxane polymer composite film on an electron emission source formation substrate; and thermally treating the carbon nanotube-polyorganosiloxane polymer composite film laminated on the electron emission source formation substrate.

### CLAIM OF PRIORITY

This application claims priority under 35 U.S.C. §119 from Korean Patent Application No.10-2004-0030257, entitled A METHOD FOR PREPARING AN EMITTER, AN EMITTER AND AN ELECTRON EMISSION DEVICE COMPRISING THE EMITTER, filed in the Korean Intellectual Property Office on Apr. 29, 2004, the disclosure of which is incorporated herein in its entirety by reference.

### BACKGROUND OF THE INVENTION

1. Field of the Invention

The present invention relates to a method of forming an electron emission source, and an electron emission device including the electron emission source. More particularly, the present invention relates to a method of forming an electron emission source including carbon nanotubes, which can control the alignment and density of the carbon nanotubes and decrease the content of impurities in the carbon nanotubes, the electron emission source, and an electron emission device including the electron emission source.

2. Description of the Related Art

Electron emission devices are displays that create images by emitting light by collision of phosphors in a phosphor layer of an anode with cold electrons which are emitted into a vacuum from electron emission sources by a tunneling effect under a strong electric field.

However, since a metal or a semiconductor material used for microtips of electron emission devices has a large work function, a higher voltage must be applied to a gate electrode. Furthermore, residual gas particles in a vacuum are ionized by collision with electrons, thereby causing damage or destruction of the microtips. In addition, phosphor particles separated from a phosphor layer by collision with electrons can contaminate the microtips. Therefore, the performance and lifespan of the electron emission devices can be lowered. To solve these problems, carbon-based electron emission sources have been recently used. Among them, carbon nanotube electron emission sources have many advantages such as a low electric field for electron emission, good chemical stability, and strong mechanical properties. Therefore, it is anticipated that the carbon nanotube electron emission sources will be substituted for electron emission sources made of metal or a semiconductor material.

The carbon nanotube electron emission sources can be fabricated by a direct alignment of carbon nanotubes on a substrate or a paste method using a composition for electron emission sources including carbon nanotubes.

With respect to the direct alignment of carbon nanotubes on a substrate, for example, a Chemical Vapor Deposition (CVD) method is used. The method can provide a relatively good density, alignment, and pattern of carbon nanotubes. However, this method has disadvantages in that it cannot be applied to large area substrates and incurs high costs. Even though the CVD method can provide carbon nanotubes with a low impurity content, process restrictions occur, such as the use of a substrate capable of withstanding a high temperature during the CVD method.

On the other hand, with respect to the paste method, there is an advantage in that a large-sized device can be fabricated at a low cost. For example, Korean Laid-Open Patent Publication No. 2003-0000086 relates to a method of forming an electron emission source by screen printing using a metal mesh screen. Korean Laid-Open Patent Publication No. 2003-0080770 relates to a method of patterning an electron emission source, which includes exposure to light and development.

In spite of these advantages, the paste method has a problem in that it cannot control the alignment (vertical orientation, for example) and density of carbon nanotubes of an electron emission source. The alignment, density, and impurity content of carbon nanotubes are important factors that must be considered in obtaining the reliability of electron emission sources. In this regard, a method of forming an electron emission source over a large area at a low cost, and which can control the alignment, density, and impurity content of carbon nanotubes at a level suitable for electron emission devices is needed.

### SUMMARY OF THE INVENTION

The present invention provides a method of forming an electron emission source including carbon nanotubes, which can control the alignment and density of the carbon nanotubes and decrease an impurity content, the electron emission source, and an electron emission device including the electron emission source.

According to an aspect of the present invention, a method of forming an electron emission source is provided, the method including: providing a carbon nanotube layer on a substrate; affixing the carbon nanotube layer to an organosiloxane-based material; curing the organosiloxane-based material affixed to the carbon nanotube layer; separating a carbon nanotube-polyorganosiloxane polymer composite film from the substrate; laminating the carbon nanotube-polyorganosiloxane polymer composite film on an electron emission source formation substrate; and thermally treating the carbon nanotube-polyorganosiloxane polymer composite film laminated on the electron emission source formation substrate.

Laminating the carbon nanotube-polyorganosiloxane polymer composite film can be carried out at a temperature of 60-100 degrees C. or using an adhesive selected from the group consisting of polyvinylacetate materials and acrylate materials.

Thermally treating the carbon nanotube-polyorganosiloxane polymer composite film can be carried out at a temperature of 400-500 degrees C.

According to another aspect of the present invention, an electron emission source formed by the abovenoted method and including a carbon nanotube layer with a density of 10⁶ to 10⁸ carbon nanotubes/square centimeter is provided.

The carbon nanotubes of the carbon nanotube layer can be vertically oriented.

According to yet another aspect of the present invention, an electron emission device including: a substrate; a cathode formed on the substrate; and the above-described electron emission source electrically connected to the cathode formed on the substrate is provided.

Carbon nanotubes in the electron emission source of the electron emission device can be vertically oriented.

According to the method of the present invention, an electron emission source including carbon nanotubes having a desired alignment and density and a low impurity content can be easily formed. Inclusion of the electron emission source in an electron emission device can enhance the reliability of the electron emission device.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic sectional view of an example of an electron emission device according to an embodiment of the present invention.

### DETAILED DESCRIPTION OF THE INVENTION

The present invention provides a method of forming an electron emission source, which includes: providing a carbon nanotube layer; contacting the carbon nanotube layer with an organosiloxane-based material; curing the organosiloxane-based material; separating a carbon nanotube-polyorganosiloxane polymer composite film; laminating the carbon nanotube-polyorganosiloxane polymer composite film; and thermally treating the carbon nanotube-polyorganosiloxane polymer composite film.

The process of providing the carbon nanotube layer can be carried out by various methods of synthesizing carbon nanotubes. In particular, a method of growing carbon nanotubes can be used. Examples of the method of growing carbon nanotubes include laser vaporization, Plasma Enhanced Chemical Vapor Deposition (PECVD), thermolysis, Thermal Chemical Vapor Deposition (TCVD), vapor phase growth, and sputtering. Among them, (TCVD) is preferable.

According to an embodiment of the process of providing the carbon nanotube layer by TCVD, first, a catalytic metal such as Fe, Ni, or Co is deposited on a substrate. Patterning of the catalytic metal determines the pattern formation of carbon nanotubes to be grown on the substrate. The patterning of the catalytic metal can be carried out by various methods such as multi-step etching or polymer stamping. Then, growing of the carbon nanotubes is carried out on a micro-patterned catalytic metal in the presence of various hydrocarbon gases such as CH₄, C₂H₂, C₂H₄, and C₂H₅OH, to obtain the carbon nanotube layer.

The growing of the carbon nanotubes can be carried out at high temperature. As a result, the carbon nanotube layer can have a high density, a good vertical orientation, and a low impurity content.

The carbon nanotube layer provided as described above contacts the organosiloxane-based material. Through the contacting process, spaces between the carbon nanotubes in the carbon nanotube layer are impregnated with the organosiloxane-based material with flowability. The impregnation of the organosiloxane-based material into the spaces between the carbon nanotubes is spontaneously carried out by gravity. Physical means such as stirring can also be used.

The organosiloxane-based material must be easily curable. After the curing, the organosiloxane-based material must be easily separated from the substrate on which the carbon nanotube layer is formed. The organosiloxane-based material that can be appropriately used herein is a mixture of a siloxane base oligomer with a vinyl group and a siloxane crosslinkable oligomer with a silicon-hydride bond. An example of the siloxane base oligomer is a compound represented by Formula 1 below and an example of the siloxane crosslinkable oligomer is a compound represented by Formula 2 below: 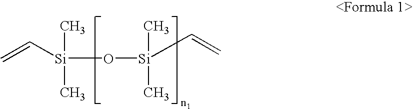
wherein n₁ is an integer of 1 to 60, and 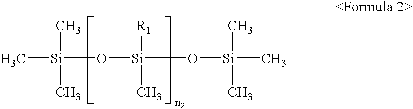
wherein R₁ is independently a hydrogen atom or a methyl group and n₂ is an integer of 1 to 10 with a proviso that if n₂ is at least 3, then three or more R₁s are hydrogen atoms.

In the curing process, the organosiloxane-based material is subjected to cross-linking by exposure to light to form a carbon nanotube-polyorganosiloxane polymer composite film.

The organosiloxane-based material is commercially available. The commercially available organosiloxane-based material can be SYLGARD 184 (Dow Corning), which is an elastomer formation kit, but is not limited thereto. An appropriate organosiloxane-based material can be easily selected by ordinary persons skilled in the art who can understand the purpose and method of the use of the above-described organosiloxane-based material.

The organosiloxane-based material impregnated into the spaces between the carbon nanotubes in the carbon nanotube layer is cured so that the carbon nanotube-polyorganosiloxane polymer composite film is formed. The curing condition can vary according to the organosiloxane-based material. An appropriate curing temperature is in a range of 15-50 degrees C. and preferably 20-30 degrees C. If the curing temperature is less than 15 degrees C., the composite film cannot be formed. On the other hand, if it exceeds 50 degrees C., the polyorganosiloxane polymer can melt.

Through the curing process, the carbon nanotube-polyorganosiloxane polymer composite film is formed. The polyorganosiloxane polymer can be polydimethylsiloxane. The carbon nanotubes of the carbon nanotube-polyorganosiloxane polymer composite film substantially maintain original density and orientation of the carbon nanotubes grown on the substrate.

The carbon nanotube-polyorganosiloxane polymer composite film formed through the above-described curing process is separated from the substrate on which the carbon nanotubes are grown. The separation can be carried out by hand. For mass production, an automatic system can be used. Through the separation, the carbon nanotubes in the carbon nanotube-polyorganosiloxane polymer composite film can be additionally vertically oriented. Therefore, in the electron emission source formation method of the present invention, an activating process for vertical orientation of the carbon nanotubes can be selectively omitted.

The carbon nanotube-polyorganosiloxane polymer composite film separated from the substrate is laminated on an electron emission source formation substrate. The electron emission source formation substrate can be made of glass, silicon, or a ceramic, but is not limited thereto.

The laminating process can be carried out by a hot lamination method using heat and pressure or a cold lamination method using an adhesive. To maintain the alignment and density of the carbon nanotubes in the carbon nanotube-polyorganosiloxane polymer composite film, the cold lamination method is preferable.

In the case of using the hot lamination method, the laminating process is carried out at a temperature of 60-100 degrees C. and preferably 70-80 degrees C. If the laminating temperature is less than 60 degrees C., the carbon nanotube-polyorganosiloxane polymer composite film can be insufficiently formed. On the other hand, if it exceeds 100 degrees C., the polyorgansiloxane polymer can melt.

In the case of using the cold lamination method, an adhesive selected from the group consisting of polyvinylacetates, acrylates, and polyurethanes can be used. Among them, cyanoacrylate or bisacrylate is preferable.

As described above, after the laminating process, the carbon nanotube-polyorganosiloxane polymer composite film is thermally treated. Through the thermal treatment process, most of the polyorganosiloxane polymer is volatilized. The thermal treatment of the polyorganosiloxane polymer serves to increase adhesion between the carbon nanotubes and the substrate.

The thermal treatment is carried out at a temperature of 400-500 degrees C. and preferably 450 degrees C. If the thermal treatment temperature is less than 400 degrees C., the polyorganosiloxane polymer can be insufficiently volatilized. As a result, the carbon nanotube layer can contain a large amount of impurities. On the other hand, if it exceeds 500 degrees C., the carbon nanotubes can be deteriorated.

In the electron emission source formation method of the present invention, after the thermal treatment process, activating of the carbon nanotubes can be omitted. According to the above-described method of forming an electron emission source of the present invention, the electron emission source includes the carbon nanotube layer having desired density and alignment by TCVD, unlike a paste method that cannot control the alignment and density of carbon nanotubes. Therefore, the electron emission source can have excellent electron emission characteristics even when the activation process for controlling the alignment and density of the carbon nanotubes is not performed.

The present invention also provides an electron emission source including a carbon nanotube layer with a density of 10⁶ to 10⁸ carbon nanotubes/square centimeter. If the density of the carbon nanotubes is less than 10⁶ carbon nanotubes/square centimeter, electron emission characteristics can be unsatisfactory. On the other hand, if it exceeds 10⁸ carbon nanotubes/square centimeter, a screening effect can occur, thereby preventing the penetration of the electric field. The electron emission source of the present invention can be formed by the above-described electron emission source formation method of the present invention.

The present invention also provides an electron emission device including an electron emission source having a carbon nanotube layer with a density of 10⁶ to 10⁸ carbon nanotubes/square centimeter.

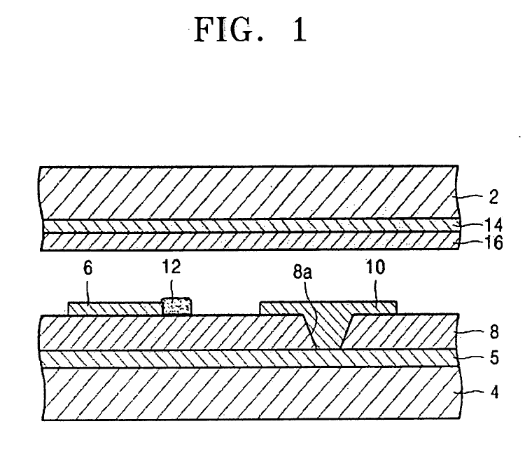

An example of the electron emission device according to an embodiment of the present invention is illustrated in FIG. 1. FIG. 1 is a view of an electron emission device having a triode structure. Referring to FIG. 1, the electron emission device includes a first substrate 2 and a second substrate 4 separated from each other by a predetermined distance to define an internal space. The second substrate 4 is formed with structures for inducing electron emission and the first substrate 2 is formed with structures for creating images by electrons emitted.

A gate electrode 5 is formed in a predetermined pattern, for example in a stripe pattern, on the second substrate 4. The gate electrode 5 is covered with an insulating layer 8. The insulating layer 8 can be made of a silicon oxide material and is formed with multiple via holes 8a. A gate island 10 is formed on the insulating layer 8 in such a way to be filled in the via holes 8a.

A cathode 6 is formed in a stripe pattern on the insulating layer 8 and perpendicularly intersects the gate electrode 5. The gate electrode 5 and the cathode 6 can be formed in various patterns, in addition to the above-described patterns.

An electron emission source 12 is formed on the insulating layer 8 so as to contact a side portion of the cathode 6. Carbon nanotubes contained in the electron emission source 12 are substantially vertically oriented and have a high density and a low impurity content.

Even though an electron emission device having a triode structure has been illustrated, electron emission devices having a diode structure, in addition to a triode structure, are also within the scope of the present invention. Furthermore, the present invention can also be applied to electron emission devices in which a gate electrode is interposed between an anode and a cathode and electron emission devices having a grid/mesh structure to prevent damage of a gate electrode and/or a cathode by an arc that might be generated by a discharge phenomenon and to focus electrons emitted from an electron emission source.

Hereinafter, the present invention will be described more specifically by way of an example. However, the following example is provided only for illustration and the present invention is not limited thereto.

A Fe catalytic metal was coated on a substrate made of glass or silicon by sputtering. Positions for growth of carbon nanotubes were adjusted using a mask. Then, an acetylene gas was allowed to flow at 700 degrees C. As a result, the carbon nanotubes were grown on the catalytic metal. The carbon nanotubes thus grown were affixed to a SYLGARD 184 kit (Dow Corning) used as a polydimethylsiloxane (PDMS) precursor and then exposed to light at room temperature to obtain a carbon nanotube-PDMS polymer composite film. Then, the carbon nanotube-PDMS polymer composite film was separated from the substrate on which the carbon nanotubes were grown. The separated carbon nanotube-PDMS polymer composite film was attached to a glass substrate coated with a bisacrylate adhesive and then thermally treated at 450 degrees C. to obtain an electron emission source.

According to an electron emission source formation method of the present invention, through laminating and thermal treatment processes of a carbon nanotube-polyorganosiloxane polymer composite film having carbon nanotubes of desired density and alignment, an electron emission source with excellent electron emission characteristics can be formed over a large area substrate at a low cost. Furthermore, the electron emission source can include carbon nanotubes having a high density, a good alignment, and a low impurity content. Therefore, inclusion of the electron emission source in an electron emission device can enhance the reliability of the electron emission device.

While the present invention has been particularly shown and described with reference to exemplary embodiments thereof, it will be understood by those of ordinary skill in the art that various changes in form and details can be made therein without departing from the spirit and scope of the present invention as defined by the following claims.

1. A method of forming an electron emission source, the method comprising:
providing a carbon nanotube layer on a substrate;
contacting the carbon nanotube layer with an organosiloxane-based material;
curing the organosiloxane-based material contacted to the carbon nanotube layer;
separating a carbon nanotube-polyorganosiloxane polymer composite film from the substrate;
laminating the carbon nanotube-polyorganosiloxane polymer composite film on an electron emission source formation substrate; and
thermally treating the carbon nanotube-polyorganosiloxane polymer composite film laminated on the electron emission source formation substrate.

2. The method of claim 1, wherein providing the carbon nanotube layer comprises using a Chemical Vapor Deposition (CVD) method.

3. The method of claim 1, wherein the organosiloxane-based material comprises a mixture of a siloxane base oligomer with a vinyl group and a siloxane crosslinkable oligomer.

4. The method of claim 3, wherein the siloxane base oligomer is represented by Formula 1 below and the siloxane crosslinkabe oligomer is represented by Formula 2 below: 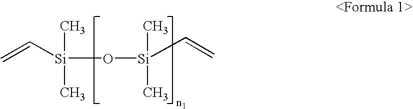
wherein n₁ is an integer between 1 and 60, and 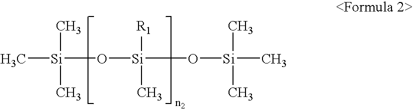
wherein R₁ is independently a hydrogen atom or a methyl group and n₂ is an integer between 1 and 10 with a proviso that if n₂ is at least 3, then three or more R₁s are hydrogen atoms.

5. The method of claim 1, wherein curing the organosiloxane-based material comprises exposure to light.

6. The method of claim 1, wherein curing the organosiloxane-based material comprises curing at a temperature of 15-50 degrees C.

7. The method of claim 1, wherein the polyorganosiloxane polymer comprises polydimethylsiloxane (PDMS).

8. The method of claim 1, wherein the carbon nanotubes in the carbon nanotube-polyorganosiloxane polymer composite film are vertically oriented.

9. The method of claim 1, wherein laminating the carbon nanotube-polyorganosiloxane polymer composite film is carried out at a temperature of 60-100 degrees C.

10. The method of claim 1, wherein laminating the carbon nanotube-polyorganosiloxane polymer composite film comprises using an adhesive selected from the group consisting of polyvinylacetate materials and acrylate materials.

11. The method of claim 1, wherein thermally treating the carbon nanotube-polyorganosiloxane polymer composite film is carried out at a temperature of 400-500 degrees C.

12. An electron emission source formed by a method comprising:
providing a carbon nanotube layer on a substrate;
contacting the carbon nanotube layer with an organosiloxane-based material;
curing the organosiloxane-based material contacted to the carbon nanotube layer;
separating a carbon nanotube-polyorganosiloxane polymer composite film from the substrate;
laminating the carbon nanotube-polyorganosiloxane polymer composite film on an electron emission source formation substrate; and
thermally treating the carbon nanotube-polyorganosiloxane polymer composite film laminated on the electron emission source formation substrate;
wherein the carbon nanotube layer has a density of 10⁶ to 10⁸ carbon nanotubes/square centimeter.

13. The electron emission source of claim 12, wherein the organosiloxane-based material comprises a mixture of a siloxane base oligomer with a vinyl group and a siloxane crosslinkable oligomer.

14. The electron emission source of claim 12, wherein the siloxane base oligomer is represented by Formula 1 below and the siloxane crosslinkabe oligomer is represented by Formula 2 below: 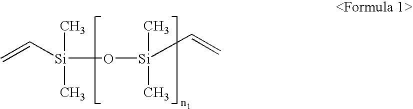
wherein n₁ is an integer between 1 and 60, and 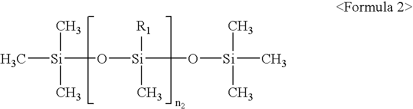
wherein R₁ is independently a hydrogen atom or a methyl group and n₂ is an integer between 1 and 10 with a proviso that if n₂ is at least 3, then three or more R₁s are hydrogen atoms.

15. The electron emission source of claim 12, wherein the polyorganosiloxane polymer comprises polydimethylsiloxane (PDMS).

16. An electron emission device comprising:
a substrate;
a cathode formed on the substrate; and
an electron emission source formed by a method comprising:
providing a carbon nanotube layer on a substrate;
contacting the carbon nanotube layer with an organosiloxane-based material;
curing the organosiloxane-based material contacted to the carbon nanotube layer;
separating a carbon nanotube-polyorganosiloxane polymer composite film from the substrate;
laminating the carbon nanotube-polyorganosiloxane polymer composite film on an electron emission source formation substrate; and
thermally treating the carbon nanotube-polyorganosiloxane polymer composite film laminated on the electron emission source formation substrate;
wherein the carbon nanotube layer has a density of 10⁶ to 10⁸ carbon nanotubes/square centimeter; and
wherein the electron emission source is electrically connected to the cathode formed on the substrate.

17. The electron emission device of claim 16, wherein the organosiloxane-based material comprises a mixture of a siloxane base oligomer with a vinyl group and a siloxane crosslinkable oligomer.

18. The electron emission device of claim 17, wherein the siloxane base oligomer is represented by Formula 1 below and the siloxane crosslinkable oligomer is represented by Formula 2 below: 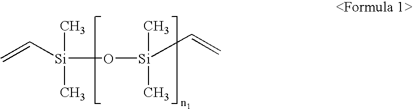
wherein n₁ is an integer between 1 and 60, and 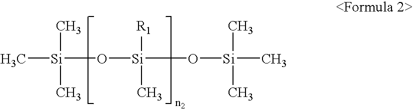
wherein R₁ is independently a hydrogen atom or a methyl group and n₂ is an integer between 1 and 10 with a proviso that if n₂ is at least 3, then three or more R₁s are hydrogen atoms.

19. The electron emission device of claim 16, wherein the polyorganosiloxane polymer comprises polydimethylsiloxane (PDMS).
